(19) United States
(12) Patent Application Publication
(10) Pub. No.: US 2016/0141584 A1
(43) Pub. Date: May 19, 2016

(54) High Voltage Electrical Center With Connectorized Bulkhead

(71) Applicant: DELPHI TECHNOLOGIES, INC., Troy, MI (US)

(72) Inventor: Daniel S. EICHORN, Auburn Hills, MI (US)

(73) Assignee: Delphi Technologies, Inc., Troy, MI (US)

(21) Appl. No.: 14/903,070

(22) PCT Filed: Jul. 21, 2014
(86) PCT No.: PCT/US14/47352

§ 371 Date: Jan. 6, 2016

Related U.S. Application Data
(60) Provisional application No. 61/858,287, filed on Jul. 25, 2013.

(51) Int. Cl. H01M 2/20; B60R 16/033; H01R 13/74; B60R 16/023

(52) U.S. Cl. CPC H01M 2/206; B60R 16/023; B60R 16/033; H01R 13/74; H01M 2220/20

(57) ABSTRACT

An electrical assembly, such as a high voltage electrical center that controls the flow of electricity between a battery pack and the propulsion system of an electric or hybrid electric vehicle. The assembly includes a plurality of electrical connectors configured to receive and mate with a plurality of corresponding mating connectors and a housing containing a plurality of electrical devices interconnected to the plurality of electrical connectors. The housing includes a bulkhead defining a plurality of connector shrouds that axially surrounds each connector in the plurality of electrical connectors. Each connector shroud is configured to receive a connector body of a corresponding mating connector. The plurality of connector shrouds is integral to the bulkhead. The bulkhead, and thereby the shrouds, may be formed of a composite conductive material containing electrically conductive fibers within a dielectric matrix.

### CROSS-REFERENCE TO RELATED APPLICATIONS

This application is a national stage application under 35 U.S.C. 371 of PCT Application No. PCT/US14/47352 having an international filing date of Jul. 21, 2014, which designated the United States, said PCT application claiming the benefit of U.S. Provisional Patent Application No. 61/858,287 filed Jul. 25, 2013. The entire disclosures of both of these applications are hereby incorporated herein by reference.

### BACKGROUND OF THE INVENTION

Full electric and hybrid electric vehicles are equipped with a battery pack contained in a conductive housing, typically a metal box. The flow of power to and from the battery is switched on and off by and routed through a high voltage electrical center containing electrical devices such as relays, precontactors, fuses, and circuit boards. Among the functions of the housing is providing EMI shielding to and from these electrical devices. Shielded cables routed to vehicle devices powered by the battery must pass through the walls of the housing. Apertures that allow passage of cables through the walls of the housing must not reduce the shielding effectiveness of the box.

In some prior art battery packs, connector headers 1 were mounted by threaded fasteners 2 to a pattern of holes 3 cut through the wall 4 of the housing as shown in FIG. 1. The shielded header connectors 5 contained a conductive shield or “can” (not shown) which makes electrical contact to the conductive battery pack housing and the mating shielded connector thus closing or maintaining an electromagnetic shield over the connecting elements of the shielded connector.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with one embodiment of this invention, an electrical assembly is provided. The electrical assembly includes a plurality of electrical connectors configured to receive and mate with a plurality of corresponding mating connectors and a housing containing a plurality of electrical devices interconnected to the plurality of electrical connectors. The housing includes a bulkhead that defines a plurality of connector shrouds. The plurality of connector shrouds axially surrounds each connector in the plurality of electrical connectors. Each connector shroud is configured to receive a connector body of a corresponding mating connector. The plurality of connector shrouds is integral to the bulkhead.

The bulkhead, and thereby the plurality of connector shrouds, is formed of a composite conductive material. The composite conductive material contains electrically conductive fibers within a dielectric matrix material.

In another embodiment of the present invention, a battery pack assembly is provided. The battery pack assembly includes a housing formed of a conductive metallic material and defining a cavity containing a plurality of electrical devices and defining an aperture within a wall of the housing. The battery pack assembly also includes a bulkhead received within the aperture. The bulkhead includes a plurality of electrical connectors configured to receive and mate with a plurality of corresponding mating connectors. The bulkhead defines a plurality of connector shrouds that axially surround each connector in the plurality of electrical connectors. Each connector shroud is configured to receive a connector body of a corresponding mating connector. The plurality of connector shrouds is integral to the bulkhead. The plurality of electrical connectors is interconnected to the plurality of electrical devices.

The bulkhead, and thereby the plurality of connector shrouds, is formed of a composite conductive material. The bulkhead is attached to the housing by a conductive fastener. The composite conductive material contains electrically conductive fibers dispersed within a dielectric matrix material.

In yet another embodiment of the present invention, an electrical connector assembly is provided. The electrical connector assembly includes a bulkhead configured to be received within an aperture defined by a housing formed of a conductive metallic material. This housing defines a cavity containing a plurality of electrical devices. The bulkhead includes a plurality of electrical connectors that are configured to receive and mate with a plurality of corresponding mating connectors. The bulkhead defines a plurality of connector shrouds that axially surround each connector in the plurality of electrical connectors. Each connector shroud is configured to receive a connector body of a corresponding mating connector. The plurality of connector shrouds is integral to the bulkhead. The plurality of electrical connectors is configured to be electrically connected to the plurality of electrical devices.

The bulkhead, and thereby the plurality of connector shrouds, is formed of a composite conductive material. The bulkhead is attached to the housing by a conductive fastener. The composite conductive material contains electrically conductive fibers within a dielectric matrix material.

Further features and advantages of the invention will appear more clearly on a reading of the following detailed description of the preferred embodiment of the invention, which is given by way of non-limiting example only and with reference to the accompanying drawings.

### BRIEF DESCRIPTION OF THE SEVERAL VIEWS OF THE DRAWING

The present invention will now be described, by way of example with reference to the accompanying drawings, in which:

FIG. 1 is an exploded perspective view of bulkhead and connectors of a high voltage electrical center in accordance with the prior art;

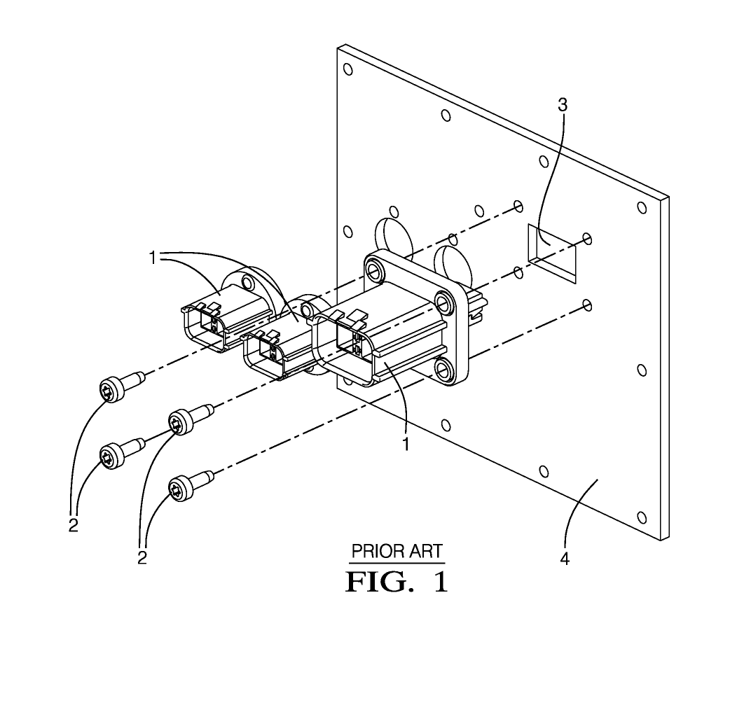

FIG. 2 is a perspective view of a high voltage electrical center in accordance with one embodiment; and

FIG. 3 is an exploded perspective view of the inner surface of the bulkhead of the high voltage electrical center of FIG. 2 in accordance with one embodiment; and

FIG. 4 is an exploded perspective view of a battery pack module including the high voltage electrical center of FIG. 2 in accordance with one embodiment.

### DETAILED DESCRIPTION OF THE INVENTION

A high voltage electrical center containing electrical devices such as relays, precontactors, fuses, and circuit boards and including headers molded from a conductive plastic to form a connectorized bulkhead is presented herein. This high voltage electrical center is mounted to and incorporated into an electric vehicle battery pack and contains the switching circuitry used to control high voltage connections between the battery pack and the vehicle's electrical propulsion system. This high voltage electrical center reduces the number of unique components required compared to the prior art. This high voltage electrical center also reduces the overall assembly effort required to construct the battery pack compared to the prior art. Additionally the high voltage electrical center may be included as part of the battery housing assembly thereby eliminating cables required by the prior art.

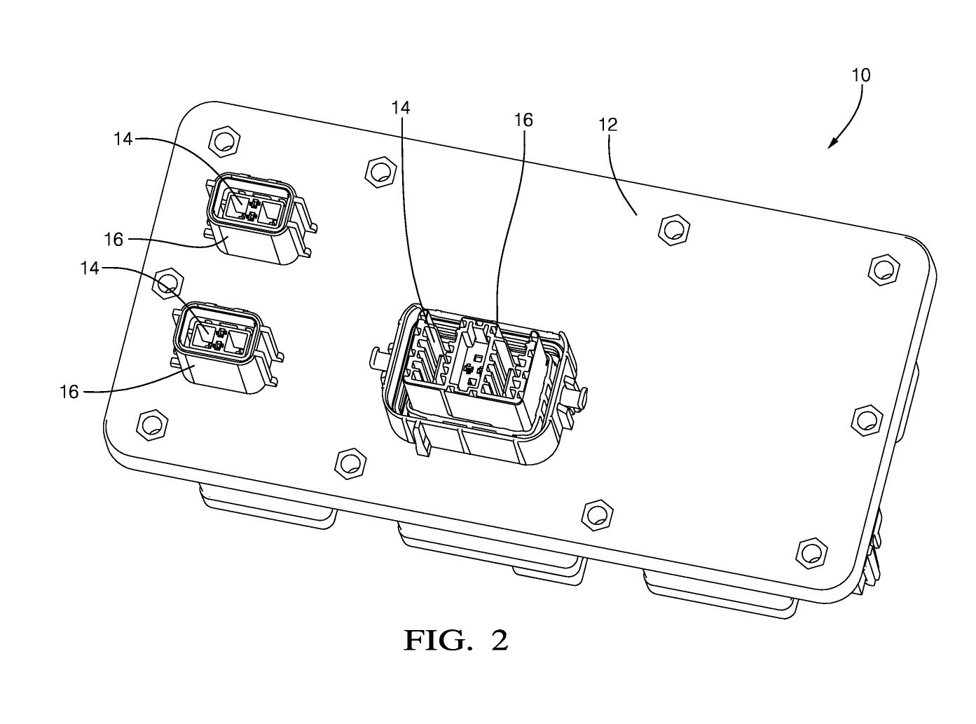

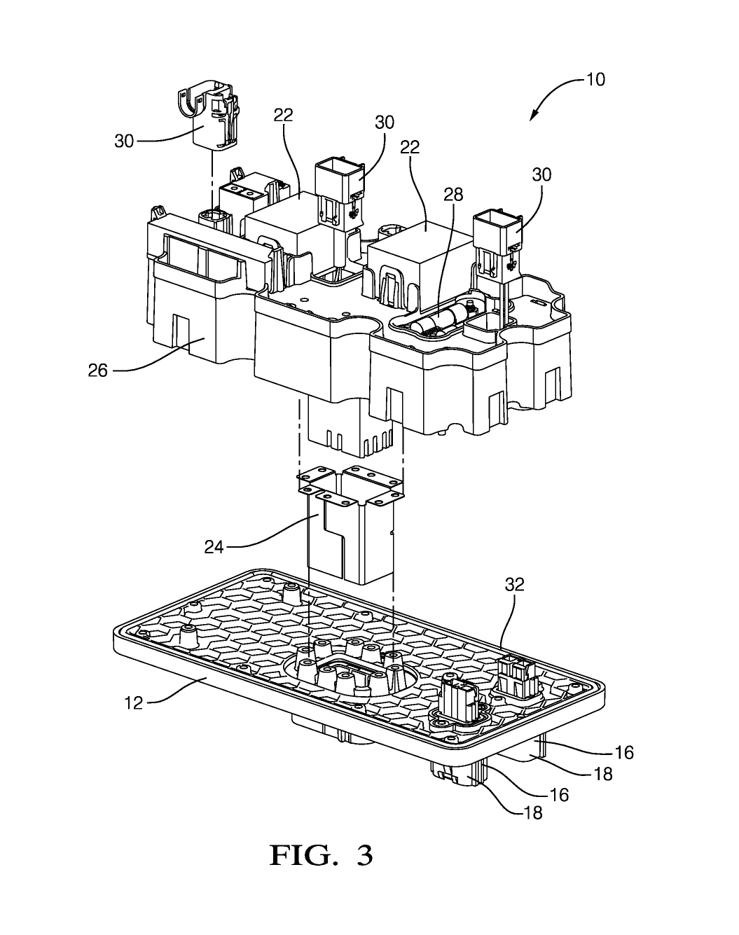

FIG. 2 illustrates a non-limiting example of an electrical assembly, such as high voltage electrical center (HVEC), generally designated by reference number 10. The assembly 10 includes a connector bulkhead 12 having a number of electrical connectors 14 that are configured to mate with corresponding mating electrical connectors(not shown) in order to interconnect the assembly 10 to the vehicle electrical propulsion system (not shown). The bulkhead 12 defines a number of connector shrouds or headers 16 that axially surround each of the assembly's electrical connectors 14. As shown in FIG. 3, these headers 16 are configured to receive the connector bodies 18 of the corresponding mating connectors. The headers 16 are integrally formed with the bulkhead 12.

The bulkhead 12 and headers 16 are formed of a conductive composite material, for example nickel plated carbon or stainless steel fibers in a PA, acrylonitrile butadiene styrene (ABS), or polycarbonate (PC) matrix. Such materials are available from ElectriPlast Corporation of Fort Washington, Pa. The bulkhead 12 may be formed by a process such as injection molding.

As shown in FIG. 3, the assembly 10 also includes an electromagnetic shield 24 or “can” that is formed of a conductive material, such as a stamped and folded metal sheet. The electromagnetic shield 24 is disposed within the connector headers 16 of the bulkhead 12 and is configured to interconnect to a corresponding electromagnetic shield in the corresponding connector, thereby providing shielding for the conductive elements of the connector and the corresponding mating connector. Because the headers 16 of the bulkhead 12 are conductive, they can provide electromagnetic shielding to the conductive elements of the connector and the corresponding mating connector. The design, materials, and fabrication methods of forming the electromagnetic shield 24 are well known to those skilled in the art.

As shown in FIG. 3, the assembly 10 includes a case 26 configured to contain the high voltage switching devices 22, as well as fuses 28, internal connectors 30, wiring (not shown), bus bars (not shown), bolts (not shown), nuts (not shown), terminal position assurance (TPA) devices (not shown), sensors (not shown), and other components in the assembly 10. The case 26 is formed of a thermoplastic material, for example a PBT or a NYLON material.

The assembly 10 also includes a compliant seal 32 to provide an environmental seal between the assembly 10 and the battery pack housing. The seal 32 may be co-molded with the bulkhead 12.

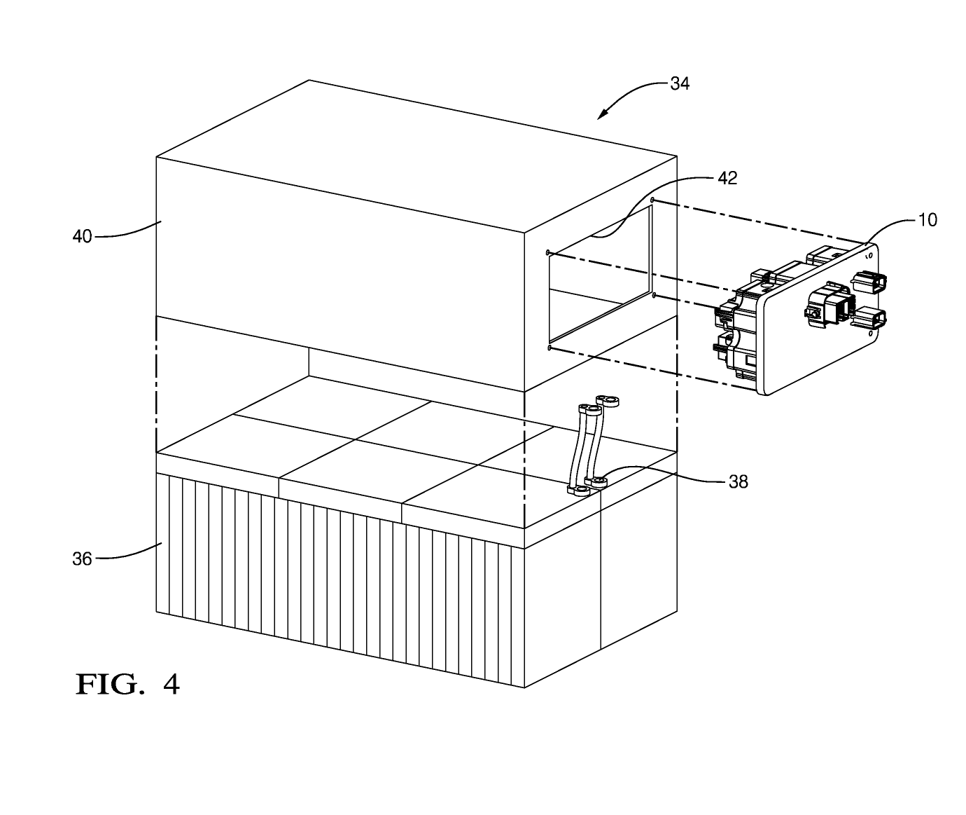

As illustrated in FIG. 4, the assembly 10 may be integrated into a battery pack module 34 of an electrical or hybrid electrical vehicle. The battery pack module 34 contains a number of battery modules 36 that are interconnected to provide a greater voltage and or current capacity than any of the battery modules 36 separately. The battery modules 36 are interconnected by a wiring harness 38 or bus bar configuration. The battery modules 36 are contained within a housing 40 formed of a conductive material, such as aluminum, that encloses the modules 36 and provides environmental protection, electrical isolation, and electromagnetic shielding for/from the battery modules 36. The housing 40 defines an aperture 42 in which the assembly 10 is received. The wiring harness/buss bar 38 of the battery pack is electrically connected to the assembly 10. The electrical devices (e.g. relays, precontactors) of the assembly 10 control the flow of electrical power to and from the battery modules 36 in the battery pack. The assembly 10 also provides the shielded electrical connections for the battery pack to electrical propulsion system and control electronics.

Accordingly, an electrical assembly 10, such as a high voltage electrical center, having a bulkhead 12 with integrally formed connector headers 16 is provided. The bulkhead 12 provides the advantage of reducing the number of unique components in the assembly 10 and reducing the assembly time needed to attach separate headers to the bulkhead 12 as used in the prior art. Molding the bulkhead 12 from conductive plastic also allows for more complex geometry to contain electromagnetic energy within the battery pack case. It also more easily allows the formation of a groove to contain the seal 32 in the bulkhead 12 and/or allows the seal 32 to be co-molded with the bulkhead 12.

While this invention has been described in terms of the preferred embodiments of a high voltage electrical center, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. An electrical assembly, comprising:
a plurality of electrical connectors configured to receive and mate with a plurality of corresponding mating connectors;
a case containing a plurality of electrical devices interconnected to the plurality of electrical connectors, said case including a bulkhead that defines a plurality of connector shrouds that axially surrounds each connector in the plurality of electrical connectors, each connector shroud is configured to receive a connector body of a corresponding mating connector, said plurality of connector shrouds is integral to the bulkhead.

2. The electrical assembly according to claim 1, wherein the bulkhead, and thereby the plurality of connector shrouds, is formed of a composite conductive material.

3. The electrical assembly according to claim 2, wherein the composite conductive material contains electrically conductive fibers within a dielectric matrix material.

4. A battery pack assembly, comprising:
a housing formed of a conductive metallic material and defining a cavity containing a plurality of electrical devices and defining an aperture within a wall of the housing,
a bulkhead received within said aperture, said bulkhead including a plurality of electrical connectors configured to receive and mate with a plurality of corresponding mating connectors, wherein said bulkhead defines a plurality of connector shrouds that axially surround each connector in the plurality of electrical connectors, each connector shroud configured to receive a connector body of a corresponding mating connector, wherein said plurality of connector shrouds is integral to the bulkhead and wherein the plurality of electrical connectors is interconnected to said plurality of electrical devices.

5. The battery pack assembly according to claim 4, wherein the bulkhead, and thereby the plurality of connector shrouds, is formed of a composite conductive material, wherein the bulkhead is attached to the housing by a conductive fastener.

6. The battery pack assembly according to claim 5, wherein the housing is formed of a conductive metallic material and wherein the bulkhead is attached to the housing by a conductive fastener.

7. The battery pack assembly according to claim 6, wherein the composite conductive material contains electrically conductive fibers within a dielectric matrix material.

8. An electrical connector assembly, comprising:
a bulkhead configured to be received within an aperture defined by a housing formed of a conductive metallic material, said housing defining a cavity containing a plurality of electrical devices, said bulkhead including a plurality of electrical connectors configured to receive and mate with a plurality of corresponding mating connectors, wherein said bulkhead defines a plurality of connector shrouds that axially surround each connector in the plurality of electrical connectors, each connector shroud configured to receive a connector body of a corresponding mating connector, wherein said plurality of connector shrouds is integral to the bulkhead and wherein the plurality of electrical connectors is configured to be electrically connected to said plurality of electrical devices.

9. The electrical connector assembly according to claim 8, wherein the bulkhead, and thereby the plurality of connector shrouds, is formed of a composite conductive material, wherein the bulkhead is attached to the housing by a conductive fastener.

10. The electrical connector assembly according to claim 9, wherein the composite conductive material contains electrically conductive fibers within a dielectric matrix material.
